(19) United States
(12) Patent Application Publication
(10) Pub. No.: US 2024/0055652 A1
(43) Pub. Date: Feb. 15, 2024

(54) SECONDARY BATTERY

(71) Applicant: TOYOTA JIDOSHA KABUSHIKI KAISHA, Toyota-shi Aichi-ken (JP)

(72) Inventor: Ximeng LI, Susono-shi Shizuoka-ken (JP)

(73) Assignee: TOYOTA JIDOSHA KABUSHIKI KAISHA, Toyota-shi Aichi-ken (JP)

(21) Appl. No.: 18/204,546

(22) Filed: Jun. 1, 2023

(30) Foreign Application Priority Data
Aug. 12, 2022 (JP) 2022-129048

(51) Int. Cl. H01M 10/0562; H01M 4/38; H01M 4/485; H01M 4/66

(52) U.S. Cl. CPC H01M 10/0562; H01M 4/382; H01M 4/485; H01M 4/669

(57) ABSTRACT

The secondary battery includes a positive electrode, a solid electrolyte layer, a negative electrode current collector, and metallic lithium as a negative electrode active material deposited between the solid electrolyte layer and the negative electrode current collector by charging, wherein a Mg mixture layer is present between the solid electrolyte layer and the negative electrode current collector, the solid electrolyte layer includes a first solid electrolyte, Mg mixture layer includes a Mg and a second solid electrolyte, and a Young's modulus of the second solid electrolyte is lower than a Young's modulus of the first solid electrolyte.

### CROSS-REFERENCE TO RELATED APPLICATION

This application claims priority to Japanese Patent Application No. 2022-129048 filed on Aug. 12, 2022 incorporated herein by reference in its entirety.

### BACKGROUND

### 1. Technical Field

The present application discloses a secondary battery.

### 2. Description of Related Art

Japanese Unexamined Patent Application Publication No. 2020-184513 (JP 2020-184513 A) discloses an all-solid-state battery including a positive electrode, a solid electrolyte layer, a negative electrode current collector, and metal lithium as a negative electrode active material deposited between the electrolyte layer and the negative electrode current collector by charging. In JP 2020-184513 A, a metal Mg layer is disposed between the solid electrolyte layer and the negative electrode current collector, so that a Li—Mg alloy as the metal lithium may be deposited at the time of charging. JP 2020-184407 A discloses an all-solid-state battery including a positive electrode, a solid electrolyte layer, a protective layer, and a negative electrode, in which the negative electrode includes metal lithium and the protective layer includes a predetermined Li complex oxide.

### SUMMARY

A secondary battery including a deposition-type metal lithium negative electrode has room for improvement in resistance and cycle characteristics.

The present application discloses the following aspects as techniques for solving the above issue.

### First Aspect

A secondary battery includes: a positive electrode; a solid electrolyte layer including a first solid electrolyte; a negative electrode current collector; metal lithium as a negative electrode active material deposited between the solid electrolyte layer and the negative electrode current collector by charging; and a Mg mixture layer existing between the solid electrolyte layer and the negative electrode current collector, the Mg mixture layer including Mg and a second solid electrolyte. A Young's modulus of the second solid electrolyte is lower than a Young's modulus of the first solid electrolyte.

### Second Aspect

In the secondary battery according to the first aspect, the Young's modulus of the second solid electrolyte is 1 GPa or more and 20 GPa or less.

Third Aspect

In the secondary battery according to the first and second aspects, the first solid electrolyte is a sulfide solid electrolyte.

Fourth Aspect

In the secondary battery according to any one of the first to third aspects, the second solid electrolyte is a complex hydride containing Li.

Fifth Aspect

The secondary battery according to any one of the first to fourth aspects further includes a protective layer existing between the Mg mixture layer and the negative electrode current collector. The protective layer includes Mg and no electrolyte.

Sixth Aspect

In the secondary battery according to any one of the first to fifth aspects, the positive electrode includes a lithium-containing oxide as a positive electrode active material.

### Seventh Aspect

In the secondary battery according to any one of the first to sixth aspects, the negative electrode current collector includes stainless-steel.

The secondary battery of the present disclosure includes a deposition-type metal lithium negative electrode, and has low resistance and cycle characteristics.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of a configuration of each of the secondary batteries 100 after charging and after discharging;

FIG. 2 schematically shows an example of each configuration of the secondary battery 100 after charging and after discharging;

FIG. 3A is a schematic diagram illustrating a manufacturing process of a secondary battery 100;

FIG. 3B is a schematic diagram illustrating a manufacturing process of a secondary battery 100; and

FIG. 3C is a schematic diagram illustrating an exemplary flow of a process for manufacturing the secondary batteries 100.

### DETAILED DESCRIPTION OF EMBODIMENTS

### 1. Secondary Battery

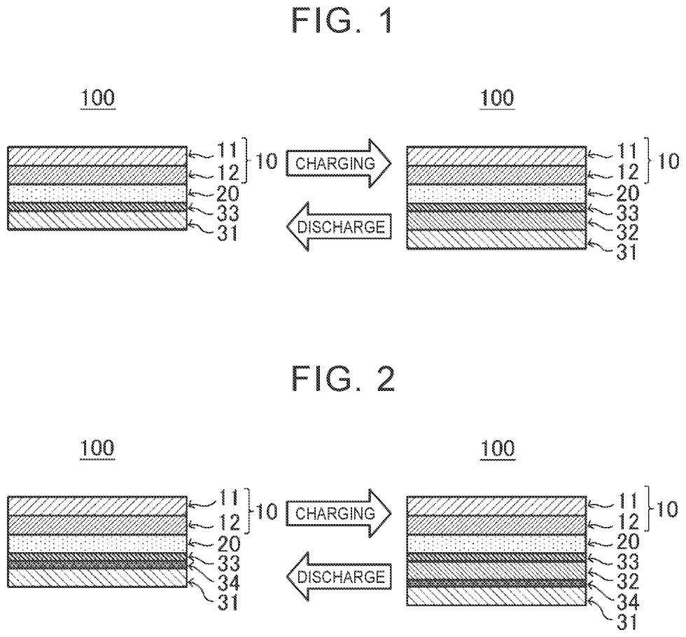

Hereinafter, a secondary battery according to an embodiment will be described with reference to the drawings. However, the technology of the present disclosure is not limited to the following embodiments. FIG. 1 shows a configuration of a secondary battery 100 according to an embodiment. As illustrated in FIG. 1, the secondary battery 100 includes a positive electrode 10, a solid electrolyte layer 20, a negative electrode current collector 31, and metal lithium 32 as a negative electrode active material deposited between the solid electrolyte layer 20 and the negative electrode current collector 31 by charging. A Mg mixture layer 33 is present between the solid electrolyte layer 20 and the negative electrode current collector 31. The solid electrolyte layer 20 includes a first solid electrolyte. Mg mixture layers 33 include Mg and a second solid-state electrolyte. The Young's modulus of the second solid electrolyte is lower than the Young's modulus of the first solid electrolyte.

### 1.1 Positive Electrode

The positive electrode 10 includes at least a positive electrode active material. When the secondary battery 100 is charged, the lithium ions released from the positive electrode active material reach between the solid electrolyte layer 20 and the negative electrode current collector 31 via the solid electrolyte layer 20, receive electrons, and precipitate as metal lithium 32. When the battery is discharged, the metal lithium 32 between the solid electrolyte layer 20 and the negative electrode current collector 31 is dissolved (ionized) and returned to the positive electrode 10. The form of the positive electrode 10 may be any known form as a positive electrode of a secondary battery. For example, as shown in FIG. 1, the positive electrode 10 may include a positive electrode current collector 11 and a positive electrode active material layer 12.

### 1.1.1 Positive Electrode Current Collector

The positive electrode current collector 11 can be any one that can function as a positive electrode current collector of a secondary battery. The positive electrode current collector 11 may be a metal foil or a metal mesh. In particular, a metal foil has handleability. The positive electrode current collector 11 may be formed of a plurality of metal foils. The positive electrode current collector 11 may be made of Cu, Ni, Cr, Au, Pt, Ag, Al, Fe, Ti, Zn, Co, stainless-steel, or the like. In particular, from the viewpoint of ensuring oxidation resistance, the positive electrode current collector 11 may contain Al. The positive electrode current collector 11 may have some coating layer on the surface thereof for the purpose of adjusting resistance or the like. When the positive electrode current collector 11 is made of a plurality of metal foils, the positive electrode current collector 11 may have some layer between the plurality of metal foils. The thickness of the positive electrode current collector 11 is not particularly limited. The thickness of the positive electrode current collector 11 may be, for example, 0.1 μm or more or 1 μm or more. The thickness of the positive electrode current collector 11 may be, for example, 1 mm or less or 100 micrometers or less.

### 1.1.2 Positive Electrode Active Material Layer

The positive electrode active material layer 12 includes a positive electrode active material. The positive electrode active material layer 12 may further optionally include an electrolyte, a conductive auxiliary agent, a binder, and the like. Further, the positive electrode active material layer 12 may contain various additives. The content of each of the positive electrode active material, the electrolyte, the conductive auxiliary agent, the binder, and the like in the positive electrode active material layer 12 may be appropriately determined in accordance with the desired battery performance. For example, the content of the positive electrode active material may be 40% by mass or more, 50% by mass or more, or 60% by mass or more, and may be 100% by mass or less, or 90% by mass or less, based on 100% by mass of the entire positive electrode active material layer 12 (the entire solid content). The shape of the positive electrode active material layer 12 is not particularly limited. The shape of the positive electrode active material layer 12 may be, for example, a sheet shape having a substantially flat surface. The thickness of the positive electrode active material layer 12 is not particularly limited. Thickness of the positive electrode active material layer 12, for example, 0.1 μm or more, 1 μm or more, may be 10 μm or more or 30 μm or more. The thickness of the positive electrode active material layers 12 may be 2 mm or less, 1 mm or less, 500 μm or less, or 100 μm or less.

The positive electrode active material may be a material known as a positive electrode active material of a secondary battery, and may be a material capable of supplying lithium to the negative electrode side during charging. For example, as the positive electrode active material, various kinds of lithium-containing oxides such as lithium cobaltate, lithium nickelate, LiNi_{1/3}Co_{1/3}Mn_{1/3}O₂, lithium manganate, and a spinel-based lithium compound can be used. Alternatively, as the positive electrode active material, a material in which lithium is occluded in sulfur can be used. In particular, when the positive electrode 10 includes a lithium-containing oxide as a positive electrode active material, lithium ions can be appropriately supplied from the positive electrode active material to the negative electrode side during charging, and expansion and contraction of the positive electrode active material during charging and discharging are small, and high performance is easily obtained. Only one positive electrode active material may be used alone. Two or more types of positive electrode active materials may be used in combination. The positive electrode active material may be in a particulate form, for example. The size is not particularly limited. The particles of the positive electrode active material may be solid particles. The particles of the positive electrode active material may be hollow particles. The particles of the positive electrode active material may be particles having voids. The particles of the positive electrode active material may be primary particles, and the particles of the positive electrode active material may be secondary particles in which a plurality of primary particles is aggregated. The mean particle diameter (D50) of the particles of the positive electrode active material may be, for example, 1 nm or more, 5 nm or more, or 10 nm or more. The mean particle size (D50) of the particles of the positive electrode active material may also be less than 500 μm, 100 μm or less, less than 50 μm, or less than 30 μm. The average particle diameter D50 referred to in the present application is a particle diameter (median diameter) at an integrated value of 50% in a volume-based particle size distribution obtained by a laser diffraction and scattering method.

The surface of the positive electrode active material may be covered with a protective layer containing an ion conductive oxide. That is, the positive electrode active material layer 12 may include a composite including the positive electrode active material described above and a protective layer provided on the surface thereof. As a result, a reaction or the like between the positive electrode active material and a sulfide (for example, a sulfide solid electrolyte, which will be described later) is easily suppressed. As an ion-conductive oxide which covers and protects the surface of positive electrode active material, for example, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄. The coverage ratio (area ratio) of the protective layer to the surface of the positive electrode active material may be, for example, 70% or more, 80% or more, or 90% or more. The thickness of the protective layers may be, for example, greater than or equal to 0.1 nm or greater than or equal to 1 nm. The thickness of the protective layers may be less than or equal to 100 nm or less than or equal to 20 nm.

The electrolyte that may be included in the positive electrode active material layer 12 may be a solid electrolyte. The electrolyte that may be included in the positive electrode active material layer 12 may be a liquid electrolyte. The electrolyte that may be included in the positive electrode active material layer 12 may be a combination thereof. In particular, when the positive electrode active material layer 12 includes a solid electrolyte (particularly, a sulfide solid electrolyte), a higher effect of the technology of the present disclosure can be expected.

As the solid electrolyte, a known solid electrolyte may be used as the solid electrolyte of the secondary battery. The solid electrolyte may be an inorganic solid electrolyte. The solid electrolyte may be an organic polymer electrolyte. In particular, the inorganic solid electrolyte has ionic conductivity and heat resistance. Examples of the inorganic solid electrolyte include an oxide solid electrolyte and a sulfide solid electrolyte. Oxide solid electrolyte may be one or more selected from lithium lanthanum zirconate, LiPON, Li₁₊ₓAlₓGe₂₋(PO₄)₃, Li—SiO based glass, Li—Al—S—O based glass and the like. The sulfide solid electrolyte may be one or more of those exemplified as the first solid electrolyte described later. Among inorganic solid electrolytes, sulfide solid electrolytes, in particular, and sulfide solid electrolytes containing at least Li, S, and P as constituent elements among them, have higher performance. The solid electrolyte may be amorphous. The solid electrolyte may be crystalline. The solid electrolyte may be, for example, in particulate form. Only one type of solid electrolyte may be used alone. Two or more types of solid electrolytes may be used in combination.

The electrolytic solution may contain, for example, lithium ions as carrier ions. The electrolytic solution may be, for example, a nonaqueous electrolytic solution. For example, as the electrolytic solution, a solution obtained by dissolving a lithium salt in a carbonate-based solvent at a predetermined concentration can be used. Examples of the carbonate solvent include fluoroethylene carbonate (FEC), ethylene carbonate (EC), dimethyl carbonate (DMC) and the like. Examples of the lithium salt include hexafluoride phosphate.

Examples of the conductive auxiliary agent that can be included in the positive electrode active material layers 12 include carbon materials such as vapor-phase carbon fibers (VGCF), acetylene black (AB), Ketjen black (KB), carbon nanotubes (CNT), and carbon nanofibers (CNF); and metallic materials such as nickel, aluminum, and stainless steel. The conductive aid may be, for example, particulate or fibrous. The size thereof is not limited in particular. Only one type of the conductive auxiliary agent may be used alone. Two or more kinds of the conductive auxiliary agents may be used in combination.

Examples of the binder that can be included in the positive electrode active material layer 12 include a butadiene rubber (BR) binder, a butylene rubber (IIR) binder, an acrylate butadiene rubber (ABR) binder, a styrene butadiene rubber (SBR) binder, a polyvinylidene fluoride (PVdF) binder, a polytetrafluoroethylene (PTFE) binder, a polyimide (PI) binder, and a polyacrylic acid-based binder. Only one binder may be used alone. Two or more kinds of binders may be used in combination.

### 1.2 Solid Electrolyte Layer

The solid electrolyte layer 20 includes at least a first solid electrolyte. The first solid electrolyte included in the solid electrolyte layer 20 may be of the same type as the solid electrolyte that may be included in the positive electrode active material layer 12. The first solid electrolyte included in the solid electrolyte layer 20 may be of a type different from the solid electrolyte that may be included in the positive electrode active material layer 12. The solid electrolyte layer 20 may further optionally contain a binder, various additives, and the like. The binder included in the solid electrolyte layer 20 may be the same type as the binder that may be included in the positive electrode active material layer 12 described above. The binder included in the solid electrolyte layer 20 may be of a type different from the binder that may be included in the positive electrode active material layer 12. In the solid electrolyte layer 20, only one type of the first solid electrolyte and the binder may be used alone, or two or more types of the first solid electrolyte and the binder may be used in combination. The solid electrolyte layer 20 need not be entirely formed of a solid. The solid electrolyte layer 20 may contain various liquids as long as it can function properly as a secondary battery. The content of the first solid electrolyte, the binder, and the like in the solid electrolyte layer 20 is not particularly limited. For example, the content of the first solid electrolyte may be 50% by mass or more, 60% by mass or more, or 70% by mass or more, based on 100% by mass of the entire solid electrolyte layer 20 (the entire solid content). For example, the content of the first solid electrolyte may be 100% by mass or less or 90% by mass or less, with the entire solid electrolyte layer 20 (the entire solid content) being 100% by mass. The thickness of the solid electrolyte layer 20 is not particularly limited. The thickness of the solid electrolyte layer 20 may be, for example, 0.1 μm or more or 1 μm or more. The thickness of the solid electrolyte layers 20 may be equal to or less than 2 mm or equal to or less than 1 mm.

In the secondary battery 100, the Young's modulus of the first solid electrolyte included in the solid electrolyte layer 20 is higher than the Young's modulus of the second solid electrolyte included in Mg mixture layer 33 described later. That is, the first solid electrolyte is harder than the second solid electrolyte described later. The Young's modulus of the first solid-state electrolyte may be, for example, greater than 20 GPa. In the present application, “Young's modulus” refers to Young's modulus at 25° C. Examples of such a hard first solid electrolyte include various ones. For example, when the first solid electrolyte is an inorganic solid electrolyte, especially a sulfide solid electrolyte, higher performance is likely to be exhibited.

The sulfide solid electrolyte may be a glass-based sulfide solid electrolyte (sulfide glass). The sulfide solid electrolyte may be a glass-ceramic sulfide solid electrolyte. The sulfide solid electrolyte may be a crystalline sulfide solid electrolyte. The sulfide glass is amorphous. In some embodiments, the sulfide glass has a glass transition temperature (Tg). When the sulfide solid electrolyte has a crystalline phase, examples of the crystalline phase include a Thio-LISICON crystalline phase, a LGPS crystalline phase, and an argyrodite crystalline phase.

In some embodiments, the sulfide solid-electrolyte contains, for example, an Li element, an X element (X is at least one of P, As, Sb, Si, Ge, Sn, B, and Al, Ga, In), and an S element. The sulfide solid electrolyte may further contain at least one of an O element and a halogen element. In some embodiments, the sulfide solid electrolyte contains an S element as a main component of an anion element.

Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where m and n are positive numbers). Z is any of Ge, Zn, Ga), Li₂S—GeS₂, Li₂S—SiS₂—Li₃PO₄, Li₂S—SiS₂-LiₓMO_{y}, where x and y are positive numbers. M is any of P, Si, Ge, B, and Al, Ga, In. It may be at least one selected from.

The composition of the sulfide solid electrolyte is not particularly limited. Examples of the sulfide solid electrolyte include xLi₂S·(100-x)P₂S₅(70≤x≤80), yLiI·zLiBr (100-y-z)(xLi₂S·(1-x)P₂S₅)(0.7≤x≤0.8, 0≤z≤30, and 0≤z≤30). Alternatively, the sulfide solid-electrolyte may have a composition represented by the general formula: Li₄₋ₓGe₁₋ₓPₓS₄ (0<x<1). In the above formulae, at least a portion of Ge may be substituted with at least one of Sb, Si, Sn, B, Al, Ga, In, Ti, Zr, V, and Nb. In the above formulae, at least a part of P may be substituted with at least one of Sb, Si, Sn, B, Al, Ga, In, Ti, Zr, V, and Nb. In the above formulae, a part of Li may be substituted with at least one of Na, K, Mg, Ca, and Zn. In the above formulae, a part of S may be substituted with a halogen (at least one of F, Cl, Br, and I). Alternatively, the sulfide solid-electrolyte may have a composition represented by Li₇₋ₐPS₆₋ₐXₐ (where X is at least one of Cl, Br and I, and a is a number of 0 or more and 2 or less). A may be 0. A may be greater than 0. In the latter case, a may be 0.1 or more, 0.5 or more, or 1 or more. In addition, a may be 1.8 or less, or 1.5 or less.

The shape of the sulfide solid electrolyte may be, for example, particulate. D50 of the sulfide solid-electrolyte may be, for example, greater than or equal to 10 nm and less than or equal to 10 μm. The ionic conductivity of the sulfide solid electrolyte at 25° C. may be, for example, 1×10⁻⁴ S/cm or more, or 1×10⁻³ S/cm or more.

### 1.3 Negative Electrode Current Collector

As the negative electrode current collector 31, any one capable of functioning as a negative electrode current collector of a secondary battery can be employed. The negative electrode current collector 31 may be a metal foil or a metal mesh. The negative electrode current collector 31 may be a carbon sheet. In particular, a metal foil has handleability and the like. The negative electrode current collector 31 may be formed of a plurality of metal foils or sheets. The negative electrode current collector 31 may be made of Cu, Ni, Cr, Au, Pt, Ag, Al, Fe, Ti, Zn, Co, stainless-steel, or the like. In particular, from the viewpoint of ensuring reduction resistance and from the viewpoint of difficulty in alloying with lithium, the negative electrode current collector 31 may include at least one kind of metal selected from Cu, Ni and stainless steel, and among them, stainless steel. The negative electrode current collector 31 may have some coating layer on its surface. For example, the surface of the negative electrode current collector 31 may be covered with a protective layer 34 described later. Alternatively, the negative electrode current collector 31 may have a coating layer other than the protective layer 34 on its surface. When the negative electrode current collector 31 is made of a plurality of metal foils, the negative electrode current collector 31 may have some layer between the plurality of metal foils. The thickness of the negative electrode current collector 31 is not particularly limited. The thickness of the negative electrode current collector 31 may be, for example, 0.1 μm or more or 1 μm or more. The thickness of the negative electrode current collector 31 may be, for example, 1 mm or less, or 100 micrometers or less.

### 1.4 Metallic Lithium as Negative Electrode Active Material

The secondary battery 100 includes a lithium deposition negative electrode. Specifically, as shown in FIG. 1, metal lithium 32 as a negative electrode active material is deposited between the solid electrolyte layer 20 and the negative electrode current collector 31 by charging. In the secondary batteries 100, as shown in FIG. 1, it is considered that metal lithium 32 is deposited at least between Mg mixture layers 33 and the negative electrode current collector 31. However, as shown in FIG. 1, the metal lithium 32 may be deposited between Mg mixture layers 33 and the negative electrode current collector 31. The metal lithium 32 may be deposited inside Mg mixture layers 33. The metal lithium 32 may be deposited between the solid electrolyte layer 20 and Mg mixture layer 33. The metal lithium 32 deposited between the electrolyte layer 20 and the negative electrode current collector 31 dissolves (ionizes) during discharge, and is returned to the positive electrode 10.

In the present application, the term “metallic lithium” is a concept including a lithium alloy in addition to lithium alone. That is, in the secondary battery 100, the metal lithium 32 may be deposited as a single lithium substance. The metal lithium 32 may be deposited as an alloy with other metals. Examples of the lithium-alloy include Li—Au, Li—Mg, Li—Sn, Li—Al, Li—B, Li—C, Li—Ca, Li—Ga, Li—Ge, Li—As, Li—Se, Li—Ru, Li—Rh, Li—Pd, Li—Ag, Li—Cd, Li—In, Li—Sb, Li—Ir, Li—Pt, Li—Hg, Li—Pb, Li—Bi, Li—Zn, Li—Tl, Li—Te and Li—At. Only one type of lithium alloy may be used. Two or more kinds of lithium alloys may be used. As will be described later, in the secondary battery 100, Mg mixture layer 33 is disposed between the solid electrolyte layer 20 and the negative electrode current collector 31. Therefore, when the secondary batteries 100 are charged, the metal lithium 32 can be alloyed with Mg contained in Mg mixture layers 33 and precipitated as a Li—Mg alloy.

The deposition amount of the metal lithium 32 between the solid electrolyte layer 20 and the negative electrode current collector 31 is not particularly limited. The deposition amount of the metal lithium 32 may be appropriately adjusted according to the desired battery performance. However, if the amount of the deposited metal lithium 32 is too large, there is a concern about concentration of pressure or the like. In this regard, the estimated deposition amount of the metal lithium 32 may be such that the charge capacity of the secondary battery 100 is, for example, not less than 1 mAh/cm², but not more than 5 mAh/cm².

According to the findings of the present inventors, in a conventional secondary battery including a lithium deposition type negative electrode, when metal lithium is repeatedly deposited and dissolved between an electrolyte layer and a negative electrode current collector, metal lithium is easily deposited and dissolved unevenly. This problem is particularly likely to occur when the current load is high. In some cases, the metallic lithium is locally overgrown. Further, when the metal lithium is unevenly deposited and dissolved, the resistance of the secondary battery increases, and the cycle characteristics also tend to deteriorate. That is, a secondary battery including a lithium deposition type negative electrode has room for improvement in resistance and cycle characteristics. In the disclosed secondary battery 100, Mg mixture layer 33 is disposed between the solid electrolyte layer 20 and the negative electrode current collector 31, so that precipitation and dissolution of the metal lithium 32 are likely to occur uniformly, and the resistivity and cycling properties can be improved.

### 1.5 Mg Mixture Layers

Mg mixture layers 33 include Mg and a second solid-state electrolyte. According to the present inventor's new knowledge, such a Mg mixture layer 33 is disposed between the solid electrolyte layer 20 and the negative electrode current collector 31, whereby lithium ions are conducted from the positive electrode 10 to the negative electrode current collector 31 through the solid electrolyte layer 20 when the secondary battery 100 is charged, and Mg in Mg mixture layer 33 and the lithium are alloyed. Here, it is considered that the interface is formed three-dimensionally by Mg mixture layers 33, and it is considered that the frequency factors of the interfacial reactivity are improved. Further, it is considered that the metal lithium 32 is deposited while being alloyed with Mg in Mg mixture layer 33, so that the metal lithium 32 and Mg mixture layer 33 come into close contact with each other due to the anchoring effect, and the interface between the metal lithium 32 and Mg mixture layer 33 is maintained satisfactorily. It is considered that the interface between the metal lithium 32 and Mg mixture layer 33 is maintained satisfactorily, so that interruption of the conductive path due to peeling of the metal lithium 32 or concentration of electric power is suppressed, and re-dissolution of the metal lithium 32 during discharging is also likely to occur uniformly. As described above, in the secondary battery 100, by disposing Mg mixture layer 33 between the solid electrolyte layer 20 and the negative electrode current collector 31, the input/output properties of lithium between the solid electrolyte layer 20 and the negative electrode current collector 31 can be improved, and local growth when the metal lithium 32 is deposited can be suppressed. It is considered that the cycle characteristics of the secondary battery 100 are improved and the resistance of the secondary battery 100 is lowered.

Further, according to the present inventor's new knowledge, since the second solid electrolyte included in Mg mixture layer 33 is softer than the first solid electrolyte included in the solid electrolyte layer 20, the resistivity of the secondary battery 100 is more likely to be lowered, and the cycling property is more likely to be improved. Specifically, since the second solid electrolyte included in Mg mixture layer 33 is softer than the first solid electrolyte included in the solid electrolyte layer 20, the second solid electrolyte is easily deformed, and the gap between the solid electrolyte layer 20 and the negative electrode current collector 31 is easily eliminated by the second solid electrolyte. In addition, due to the deformation of the second solid-state electrolyte, the packing ratio of Mg mixture layers 33 itself tends to increase. Furthermore, the presence of the soft second solid electrolyte tends to suppress interfacial delamination. Accordingly, it is considered that the conductive path and the ion conductive path are better maintained between the solid electrolyte layer 20 and the negative electrode current collector 31, the resistance of the secondary battery 100 is further lowered, and the cycle characteristics are further improved.

As shown in FIG. 1, Mg mixture layer 33 may or may not be in contact with the solid electrolyte layer 20. Even if any intermediate layer is present between Mg mixture layer 33 and the solid electrolyte layer 20, Mg mixture layer 33 may be effective. However, when Mg mixture layer 33 contacts the solid electrolyte layer 20, it is easy to ensure higher efficacy.

### 1.5.1 Mg

In Mg mixture layers 33, Mg may be present as Mg grains. On Mg grains, the nuclei of metallic lithium-32 are easily formed stably. Therefore, by including Mg grains in Mg mixture layers 33, the metal lithium 32 is more stably precipitated. In addition, since Mg has a wide compositional range capable of forming a single phase with Li, more efficient dissolution and precipitation of lithium can be performed.

Mg particles may be particles of Mg alone. Mg particles may be particles that contain Mg and elements other than Mg. Examples of the element other than Mg include various metal elements, metalloid elements, and non-metal elements. In some embodiments, Mg particles may be alloy particles (Mg alloy particles) that contain Mg and a metal other than Mg. Mg alloy grains are alloys containing Mg as a main component (alloys in which 50 mol % or more of all constituent elements are Mg). Mg alloy-particle may include, for example, at least one of Li, Au, Al and Ni as the metal M other than Mg. Mg alloying grains may contain Li. Mg alloy-grains may be free of Li. Mg alloy grains may comprise alloys of Li and Mg beta single phase. Alternatively, Mg particles may be oxide particles (Mg oxide particles) comprising Mg and O. Mg oxide particles may be, for example, particles of an oxide consisting only of Mg and O. Mg oxide particles may be particles of a complex oxide represented by Mg-M′—O (M′ is at least one of Li, Au, Al and Ni). In some embodiments, when Mg oxide grains contain M′, M′ contains at least Li. M′ may contain a metal other than Li. M′ may not contain a metal other than Li. In the former cases, M′ may be one kind of metal other than Li or two or more kinds thereof.

Mg particles may be primary particles. Mg particles may be secondary particles in which primary particles are aggregated. In some embodiments, the mean particle size (D50) of Mg particles is smaller. When the mean particle diameter of Mg particles is small, it is considered that the dispersibility of Mg particles is improved in Mg mixture layer 33, the deposition starting point of Li is increased, and the metal lithium 32 can be deposited more uniformly. The mean particle diameter (D50) of Mg particles may be, for example, 100 nm or more and 100 μm or less, and may be 200 nm or more, 300 nm or more, 400 nm or more, 500 nm or more, 600 nm or more, 700 nm or more, or 800 nm or more. The mean particle size (D50) of Mg particles may be 50 μm or less, 40 μm or less, 30 μm or less, 20 μm or less, 10 μm or less, 5 μm or less, or 3 μm or less. The average particle diameter (D50) of Mg particles may be the same as, larger than, or smaller than the average particle diameter (D50) of the second solid-state electrolyte described later.

The quantity of Mg contained in Mg mixture layers 33 is not particularly limited. From the viewpoint of increasing the deposition starting point of Li described above, the quantity of Mg may be large. In addition, from the viewpoint of enhancing the ionic conductivity of Mg mixture layers 33, the amounts of Mg may be small. For example, Mg mixture layers 33 may contain Mg in an amount of 10% by mass or more and 90% by mass or less. The content of Mg in Mg mixture layers 33 may be 20% by mass or more, 30% by mass or more, or 40% by mass or more. The content of Mg in Mg mixture layers 33 may be 80% by mass or less, 70% by mass or less, or 60% by mass or less.

### 1.5.2 Second Solid Electrolyte

The Young's modulus of the second solid electrolyte included in Mg mixture layer 33 is lower than the Young's modulus of the first solid electrolyte included in the solid electrolyte layer 20. That is, the second solid electrolyte is softer than the first solid electrolyte described above. The Young's modulus of the second solid-state electrolyte may be, for example, greater than or equal to 1 GPa and less than or equal to 20 GPa. It is considered that the lower the Young's modulus of the second solid electrolyte is, the higher the deformation performance of the second solid electrolyte is, and the effect of eliminating the above-described gap is easily exhibited. In this regard, the Young's ratio of the second solid electrolyte may be 18 GPa, hereafter 16 GPa, hereafter 14 GPa, hereafter 12 GPa, hereafter 10 GPa, hereafter 8 GPa, hereafter 6 GPa, hereafter 4 GPa, or 2 GPa. In Mg mixture layers 33, various types of such soft second solid-state electrolytes may be employed.

For example, the second solid-state electrolyte may be a complex hydride comprising Li. The complex hydride satisfies the Young's modulus and has low reactivity with the sulfide solid electrolyte. That is, when a sulfide solid electrolyte is employed as the first solid electrolyte, the reaction between the first solid electrolyte and the second solid electrolyte can be suppressed, and the durability of the battery tends to increase. The complex hydride may be composed of Li ions and complex ions containing H. The complex ion containing H may have, for example, an element M containing at least one of a non-metal element, a metalloid element, and a metal element, and H bonded to the element M. Further, the complex ion containing H may be bonded to each other through a covalent bond between the element M as a central element and H surrounding the element M. The complex ion containing H may be represented by (MₘHₙ)^{α-}. In this case, m is any positive number. n and a may be any positive number depending on m and the equivalent number of the element M. The element M may be a non-metal element or a metal element capable of forming a complex ion. For example, the element M may include at least one of B, C, and N as a non-metallic element, and may include B. Further, for example, the element M may include at least one of Al, Ni and Fe as the metallic element. Especially when the complex ion contains B or C and B, it is easy to ensure soft and higher ion conductivity. Examples of complex ions including H include (CB₉H₁₀)⁻, (CB₁₁H₁₂)⁻, (B₁₀H₁₀)²⁻, (B₁₂H₁₂)²⁻, (BH₄)⁻, (NH₂)⁻, (AlH₄)⁻, and combinations of the above. In particular, when (CB₉H₁₀)⁻, (CB₁₁H₁₂)⁻, or a combination thereof is used, higher ionic conductivity is likely to be ensured. That is, the complex hydride containing Li may contain Li, C, B, and H.

The second solid electrolyte may be a salt having a plurality of types of cations and/or a plurality of types of anions. The second solid electrolyte may alternatively be a molten salt obtained by melting a plurality of types of salts. In this case, the second solid electrolyte may contain an organic cation or an organic anion. Some of these salts satisfy the Young's modulus described above.

When the second solid electrolyte is a salt, the second solid electrolyte may have, for example, a first cation and a second cation. The first cation may be at least one selected from the ammonium ion, phosphonium ion, pyridinium ion, and pyrrolidinium ion. The second cation may be a lithium ion. The first cation may be a tetraalkylammonium ion. The second cation may be a lithium ion. When the second solid electrolyte has an organic cation as the first cation, the Young's modulus tends to be lower than when the second solid electrolyte does not have the first cation. The molar ratio of the first cation and the second cation constituting the second solid electrolyte is not particularly limited. The molar ratio of the second cation to the first cation (the second cation/the first cation) may be 0.05 or more and 19.0 or less from the viewpoint of further enhancing the ion conductivity. The molar ratio may be 0.1 or more, 0.2 or more, 0.3 or more, 0.4 or more, 0.5 or more, 0.6 or more, 0.7 or more, 0.8 or more, 0.9 or more, or 1.0 or more. The molar ratio may be 10.0 or less, 9.5 or less, 9.0 or less, 8.5 or less, 8.0 or less, 7.5 or less, 7.0 or less, 6.5 or less, 6.0 or less, 5.5 or less, or 5.0 or less. The cation constituting the second solid electrolyte may be composed of only the first cation and the second cation. The cations constituting the second solid electrolyte may include other cations different from the first cations. Examples of the other cations include ions containing a poor metal element. Examples of the poor metal include Al and Ga. The total ratio of the first cation and the second cation to the total of the cations constituting the second solid electrolyte may be 50 mol % or more and 100 mol % or less. The ratio of the total of the above-mentioned first and second cations to the entire cation constituting the second solid electrolyte may be 60 mol %, 70 mol % or more, 80 mol %, 90 mol % or more, 95 mol % or more, 99 mol % or more or 100 mol %.

When the second solid electrolyte is a salt, the second solid electrolyte may have, for example, various anions. For example, the second solid electrolyte may have at least one anion selected from a complex ion including a halogen ion, a halide ion, a hydrogen sulfate ion, a sulfonylamide ion, and H. Alternatively, the second solid electrolyte may have one or both of the first anion and the second anion. The first anion may be one or both of a halogen ion and a hydrogen sulfate ion. The second anion may be a sulfonylamide anion. Alternatively, the second solid electrolyte may have a sulfonylamide ion. The halogen ion may be, for example, one or both of a bromine ion and a chloride ion. Examples of sulfonylamide anions include: trifluoromethane sulfonamide anion (TFSA anion CF₃SO₂)₂N⁻), FSA sulfonylamide anion (FSA anion (FSO₂)₂N⁻, fluorosulphonyl (trifluoromethanesulphonyl) amide anion (FTA anion, FSO₂(CF₃SO₂)N⁻). The sulfonylamide anion may be only one kind or may be a combination of two or more kinds. Among the sulfonylamide anions, TFSA anions are low in polarity and particularly low in reactivity with other materials. In this regard, when the second solid electrolyte has TFSA anions, for example, reacting with the sulfide solid electrolyte is easily suppressed. The complex ion containing H is as described above.

The quantity of the second solid-state electrolyte contained in Mg mixture layers 33 is not particularly limited. The amount of the second solid electrolyte may be large from the viewpoint that the gap formed between the solid electrolyte layer 20 and the negative electrode current collector 31 can be more easily eliminated, from the viewpoint that the ion conductivity is enhanced, and the like. In addition, from the viewpoint of increasing Mg and increasing the deposition starting point of Li, the number of the second solid-state electrolytes may be small. For example, Mg mixture layers 33 may contain 10% by mass or more and 90% by mass or less of the second solid electrolyte. The content of the second solid electrolyte in Mg mixture layers 33 may be 20% by mass or more, 30% by mass or more, or 40% by mass or more. The content of the second solid electrolyte in Mg mixture layers 33 may be 80% by mass or less, 70% by mass or less, or 60% by mass or less.

### 1.5.3 Other Ingredients

Mg mixture layers 33 may optionally contain a binder. As a result, cracking or the like in Mg mixture layers 33 can be suppressed. The binder may be appropriately selected from those exemplified as the binder that may be included in the positive electrode active material layer. The binder that may be included in Mg mixture layer 33 may be the same type as or different from the binder that may be included in the positive electrode active material layer described above. Only one binder may be used alone, or two or more binders may be used in combination.

### 1.5.4 Fill Factor

The packing ratio of Mg mixture layers 33 is not particularly limited. When the filler ratio of Mg mixture layers 33 is high, the cycling properties of the secondary batteries tend to be better. The packing ratio of Mg mixture layers 33 may be, for example, 70% or more and 100% or less. The filling ratio may be 80% or more, 90% or more, 95% or more, or 98% or more. The packing ratio of Mg mixture layers 33 can be calculated by the following methods. That is, the sum of the volumes obtained by dividing the weights of the respective materials (Mg particles, the second solid electrolyte, and the like) included in Mg mixture layer 33 by the true densities of the respective materials is defined as “the volume of Mg mixture layer calculated from the true densities”, the volume calculated from the dimensions of the actual Mg mixture layer is defined as “the volume of the actual Mg mixture layer”, and the fill ratio (%) can be obtained from the following equation.

Filling ratio (%)=(volume of Mg mixture layer calculated from true density)/(volume of actual Mg mixture layer)×100.

### 1.5.5 Thickness, Etc.

The secondary batteries 100 may include only one Mg mixture layer 33 or two or more layers. The total thickness of Mg mixture layers 33 may be, for example, 0.1 μm or more and 1000 μm or less. As a method of forming Mg mixture layers 33, for example, a method of applying a slurry including at least Mg grains and a second solid-state electrolyte on a substrate is exemplified. Alternatively, a particle layer containing Mg particles is formed, and then the particle layer is impregnated with an electrolyte solution in which the second solid electrolyte is dissolved, and then dried.

### 1.6 Protective Layer

As shown in FIG. 2, in the secondary battery 100, the protective layer 34 may be present between Mg mixture layer 33 and the negative electrode current collector 31. The protective layers 34 may include Mg and may not include an electrolyte. By disposing the protective layer 34 between Mg mixture layer 33 and the negative electrode current collector 31, Li can be further diffused. In addition, when the protective layer 34 is present, since the second solid electrolyte contained in Mg mixture layer 33 is not in direct contact with the negative electrode current collector 31, the deposition starting point of the metal lithium 32 can be substantially only on Mg of Mg mixture layer 33 and the protective layer 34. As a result, the metal lithium 32 can be deposited more uniformly. Note that FIG. 2 illustrates a configuration in which an interface between the metal lithium 32 and the protective layer 34 is present after the secondary battery 100 is charged. However, the protective layer 34 may be entirely alloyed with the metal lithium 32.

In some embodiments, the protective layer 34 is a layer having the largest molar ratio of Mg in all constituent elements thereof. The molar fraction of Mg in the entire protective layer 34 may be, for example, not less than 50 mol % and not more than 100 mol %. The molar fraction of Mg in the entire protective layer 34 may be 70 mol % or more, 80 mol % or more, or 90 mol % or more. The protective layer 34 may be, for example, one of a metallic thin film (for example, a vapor-deposited film) including Mg or a layer including Mg grains. The metallic thin film comprising Mg may be composed of Mg or Mg alloys. Mg grains are as described above. The protective layer 34 may be a layer that contains only Mg grains.

The thickness of the protective layers 34 may be, for example, 10 nm or more and 10 micrometers or less. The thickness of the protective layers 34 may be greater than or equal to 50 nm or greater than or equal to 100 nm. The thickness of the protective layer 34 may be 5 μm or less, 3 μm or less, 1 μm or less or 700 nm or less. The secondary battery 100 may include only one protective layer 34. The secondary battery 100 may include two or more protective layers 34. Examples of the method of forming the protective layers 34 include a method of forming a film on a negative electrode current collector and a method of pressing Mg grains. As a method of forming a film on the negative electrode current collector, for example, a PVD method such as a vapor deposition method or a sputtering method, or a plating method such as an electrolytic plating method or an electroless plating method can be employed.

As shown in FIG. 2, Mg mixture layer 33 and the protective layer 34 may be contacted with each other. In addition, Mg mixture layer 33 and the solid electrolyte layer 20 may be contacted with each other. The protective layer 34 and the negative electrode current collector 31 may be in contact with each other. Alternatively, as shown in FIG. 1, Mg mixture layers 33 and the negative electrode current collector 31 may be contacted with each other.

### 1.7 Other Components

The secondary battery 100 may have at least the above-described configurations. The secondary battery 100 may further include other members. The member described below is an example of other members that the secondary battery 100 may have.

### 1.7.1 Exterior Body

In the secondary battery 100, each of the above-described configurations may be accommodated in an exterior body. More specifically, a portion excluding a tab, a terminal, or the like for extracting electric power from the secondary battery 100 to the outside may be accommodated in the exterior body. As the exterior body, any one known as an exterior body of a battery can be employed. For example, a laminate film may be used as the exterior body. Further, the plurality of secondary batteries 100 may be electrically connected to each other, and may be arbitrarily superposed to form the plurality of secondary batteries 100 as a battery pack. In this case, the assembled battery may be accommodated in a known battery case.

### 1.7.2 Sealing Resin

In the secondary battery 100, the components described above may be sealed with resin. For example, at least a side surface (a surface along the lamination direction) of each layer shown in FIG. 1 may be sealed with resin. As a result, it is easy to suppress the mixing of moisture and the like into the inside of each layer. As the sealing resin, a known curable resin or thermoplastic resin can be employed.

### 1.7.3 Restraining Member

The secondary battery 100 may or may not have a restraining member for restraining each of the above-described configurations in the thickness direction. When the restraining pressure is applied by the restraining member, the internal resistance of the battery is easily reduced. The restraining pressure by the restraining member is not particularly limited. The secondary battery 100 has a low resistance and has cycle characteristics even when the restraining pressure of the restraining member is small. In this regard, the restraining pressure by the restraining member may be less than or equal to 5 MPa, less than or equal to 3 MPa, or less than or equal to 1 MPa.

### 2. Method for Manufacturing Secondary Battery

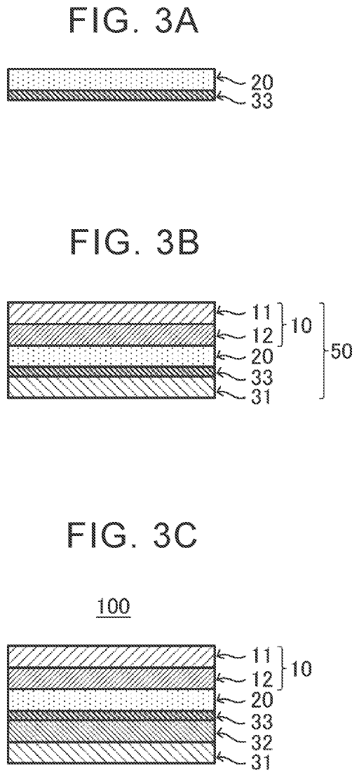

The secondary battery 100 described above can be manufactured, for example, as follows. That is, as shown in the FIG. 3B from the FIG. 3A, a manufacturing process of the secondary battery 100 according to an embodiment is described.
The solid electrolyte layer 20 including the first solid electrolyte is coated with Mg mixture layer 33 including Mg and the second solid electrolyte (FIG. 3A),
Using the solid electrolyte layer 20 coated with Mg mixture layer 33, to obtain a laminate 50 having a positive electrode 10, the solid electrolyte layer 20, Mg mixture layer 33, and the negative electrode current collector 31 in this order (FIG. 3B), and
The method includes charging the laminate 50 to deposit metal lithium 32 between the solid electrolyte layers 20 and the negative electrode current collector 31 (see 3C).

### 2.1 Coating

As shown in 3A, in the manufacturing process according to the present embodiment, the solid electrolyte layer 20 including the first solid electrolyte is coated with Mg mixture layer 33 including Mg and the second solid electrolyte. The solid electrolyte layer 20 is obtained, for example, by molding an electrolyte mixture containing a first solid electrolyte. There is no particular limitation on how Mg mixture layer 33 covers the surface of the solid electrolyte layer 20. For example, Mg mixture layer 33 may be formed on the solid electrolyte layer 20 by a coating method using solutions or slurries. Alternatively, Mg mixture layer 33 may be transferred from the transfer material to the surface of the solid electrolyte layer 20 after the transfer material having Mg mixture layer 33 formed on the base material is obtained. The solid electrolyte layer 20 may be integrated with the positive electrode active material layer 12 and the like in advance.

### 2.2 Preparation of Laminates

As shown in 3B, in the manufacturing process according to the present embodiment, the solid-state electrolyte layer 20 coated with Mg mixture layer 33 is used as described above to obtain the laminate 50 having the positive electrode 10, the electrolyte layer 20, Mg mixture layer 33, and the negative electrode current collector 31 in this order. For example, the positive electrode current collector 11, the positive electrode active material layer 12, the solid electrolyte layer 20, Mg mixture layer 33, and the negative electrode current collector 31 described above are laminated in this order, and the respective materials described above are coated, transferred, adhered, or pressed, and the like, whereby the respective materials are molded and laminated, whereby the laminate 50 can be easily obtained. The protective layer 34 described above may be provided in advance on the surface of the negative electrode current collector 31. The laminate 50 may include at least one of the positive electrode current collector 11, the positive electrode active material layer 12, the solid electrolyte layer 20, Mg mixture layer 33, and the negative electrode current collector 31. In other words, the laminate 50 may have at least one laminated unit of the positive electrode current collector 11, the positive electrode active material layer 12, the solid electrolyte layer 20, Mg mixture layer 33, and the negative electrode current collector 31 described above. The laminate 50 may include a plurality of the stacked units. In this case, a plurality of stacked units may be electrically connected in series with each other. A plurality of stacked units may be connected in parallel. The plurality of stacked units may not be electrically connected to each other.

Pressure may be applied to each of the layers or the laminate 50 in the thickness direction (stacking direction) before or after obtaining the laminate 50. For example, the layers constituting the laminate 50 may be pressed and integrated, or the interfacial resistance may be reduced by eliminating the gaps between the layers constituting the laminate 50. Each layer or laminate 50 may be pressurized by known techniques. For example, each layer or laminate 50 can be pressed in the lamination direction by various pressing methods such as CIP, HIP, roll pressing, uniaxial pressing, and mold pressing. The magnitude of the pressure applied to each layer or the laminate 50 in the stacking direction can be appropriately determined in accordance with the performance of the target battery. For example, when the sulfide solid electrolyte is included in each layer or the laminate 50, the sulfide solid electrolyte may be plastically deformed to easily perform the above-described integration or clearance elimination, and the pressure may be 100 MPa or more, 150 MPa or more, 200 MPa or more, 250 MPa or more, 300 MPa or more, or 350 MPa or more. The pressurizing time and the pressurizing temperature of each layer or laminate 50 are not particularly limited.

### 2.3 Charging

As shown in 3C, in the manufacturing process according to the present embodiment, the laminate 50 obtained as described above is charged, and metal lithium 32 is deposited between the solid electrolyte layers 20 and the negative electrode current collector 31. Specifically, when the laminate 50 is charged, lithium ions are conducted from the positive electrode active material contained in the positive electrode active material layer 12 to the negative electrode current collector 31 side through the solid electrolyte layer 20, and the lithium ions receive electrons between the solid electrolyte layer 20 and the negative electrode current collector 31 and precipitate as metal lithium 32. Charging may be the first charge after preparing the laminate 50, or may be the second and subsequent charges. The laminate 50 may be charged by a method similar to a general method of charging a battery. That is, an external power source may be connected to the positive electrode current collector 11 and the negative electrode current collector 31 of the laminate 50, and charging may be performed.

### 2.4 Other Processes

The manufacturing method according to the present embodiment may include a general process for manufacturing a secondary battery in addition to the above-described processes. Typical steps include, for example, a step of accommodating the laminate 50 inside an exterior body such as a laminate film, a step of connecting a current collector tab to the laminate 50, and the like. Specifically, for example, the current collector tabs may be connected to the current collectors 11 and 31 of the laminate 50 (a portion of the current collectors 11 and 31 may be protruded and used as tabs), and the laminate 50 may be accommodated in a laminate film as an exterior body, while the laminate film is sealed in a state in which the tabs are pulled out to the outside of the laminate film, and thereafter, the laminate 50 may be charged via the tabs outside the laminate film.

### 3. Vehicle Having Secondary Battery

As described above, the secondary battery of the present disclosure can uniformly deposit metallic lithium between the solid electrolyte layer and the negative electrode current collector, has low resistance, and has cycle characteristics. Such secondary batteries can be suitably used, for example, in at least one type of vehicles selected from hybrid electric vehicle (HEV), plug-in hybrid electric vehicle (PHEV) and battery electric vehicle (BEV). That is, the disclosed technique is a vehicle having a secondary battery, wherein the secondary battery includes a positive electrode, an electrolyte layer, a negative electrode current collector, and a metallic lithium as a negative electrode active material deposited between the electrolyte layer and the negative electrode current collector by charging, wherein a Mg mixture layer is present between the solid electrolyte layer and the negative electrode current collector, the solid electrolyte layer includes a first solid electrolyte, Mg mixture layer includes a Mg and a second solid electrolyte, and a Young's modulus of the second solid electrolyte is lower than a Young's modulus of the first solid electrolyte. Details of the configuration of the secondary battery are as described above.

As described above, an embodiment of the technology of the present disclosure has been described. However, the technology of the present disclosure can be variously modified in addition to the above-described embodiments without departing from the gist thereof. Hereinafter, the technology of the present disclosure will be described in more detail with reference to examples. However, the technology of the present disclosure is not limited to the following examples.

### 1. Preparation of Positive Electrode Mixture

A ternary positive electrode active material (LiN_{1/3}Co_{1/3}Mn_{1/3}O₂) 800 mg, a sulfide solid-electrolyte (LiBr—LiI—LiS₂—P₂S₅) 127 mg, and VGCF 12 mg as a conductive aid were dispersed in dehydrated heptane using an ultrasonic homogenizer. Thereafter, the mixture was dried at 100° C. for 1 hour to obtain a positive electrode mixture.

### 2. Preparation of Mg Coated SUS Collector Foil (Mg-SUS Foil)

A SUS coated Mg collector foil (Mg-SUS foil) was obtained by depositing Mg on the surface of SUS foil and forming a Mg layer as a protective layer on the surface of the foil. The thickness of Mg layers was 700 nm.

### 3. Preparation of Mg Mixture Layers

### 3.1 Comparative Example 1

Solutions containing SBR as binders and solvents (mesitylene, dibutyl ether) were charged to a PP vessel and mixed in a shaker for 3 minutes. Thereafter, the sulfide solid-electrolyte particles (average particle diameter D50:800 nm, Young's modulus: 23.2 GPa) and Mg particles (average particle diameter D50:800 nm) were weighed so as to be 50:50 by mass, and charged into a PP container. After mixing for 3 minutes with a shaker, the mixture was mixed for 30 seconds with an ultrasonic disperser, and this was repeated twice to obtain a Mg mixture slurry. Subsequently, Mg mixture was coated onto Al foil using an applicator with a coating gap of 25 micrometers. Mg mixture layers according to Comparative Example 1 were formed on Al foil by visually confirming that the coated surface was dried and then drying the coated surface on a hot plate at 100° C. for 30 minutes.

### 3.2 Example 1

A Mg mixture layer was formed on Al foil in the same manner as in the comparative example, except that complex hydride particles ([LiCB₉H₁₀]_{0.7}[LiCB₁₁H₁₂]_{0.3}, mean particle diameter D50:2 μm, Young's modulus: 1.5 GPa) were used instead of the sulfide solid electrolyte particles.

### 4. Preparation of Evaluation Cells

### 4.1 Comparative Example 1 and Example 1

In a green press cell (911.28 mm), sulfide solid-electrolyte particles (Young's modulus: 23.2 GPa) were 101.7 mg charged. The charged sulfide solid electrolyte particles were allowed to stand for 1 minute while 1 ton press pressure was applied, whereby a first pellet made of a solid electrolyte was obtained. Thereafter, the positive electrode mixture was 31.3 mg charged to one side of the first pellet. The first pellet and the positive electrode mixture were allowed to stand at a 6 ton press pressure for 1 minute to obtain a second pellet comprising a solid electrolyte layer-positive electrode mixture layer. Subsequently, Al foil having Mg mixture layers formed thereon was placed on the other side of the second pellet. Mg mixture layer was transferred to the surface of the solid electrolyte layer, and Al foil on which the second pellet and Mg mixture layer were formed was pressed by 1 ton, whereby a third pellet consisting of Mg mixture layer-solid electrolyte layer-positive electrode mixture layer was obtained by peeling Al foil. Finally, a Mg-SUS foil (φ11.28 mm) was placed on Mg mixture layers of the third pellets. The third pellet and Mg-SUS foil were allowed to stand at a 1 ton press pressure for 1 minute to obtain a fourth pellet comprising a SUS foil (negative electrode current collector), a Mg layer (protective layer), a Mg mixture layer, a solid electrolyte layer, and a positive electrode mixture layer. The fourth pellet was constrained by 1 MPa torques, resulting in an evaluating cell.

### 4.2 Comparative Example 2

Evaluation cells were obtained in the same manner as above, except that Mg mixture layers were not transferred to the second pellets. That is, Mg-SUS foil (911.28 mm) was placed on the other side of the second pellet. The second pellet and Mg-SUS foil were allowed to stand at a 1 ton press pressure for 1 minute to obtain a pellet composed of a SUS foil-Mg layer-a solid electrolyte layer-a positive electrode mixture layer. This was then constrained by 1 MPa torques, resulting in an evaluating cell.

### 5. Charge/Discharge Evaluation

Each evaluation cell was homogenized in a thermostat at 25° C. or 60° C. for 3 hours, and then each evaluation cell was charged and discharged for 3 cycles in a 0.2 C, followed by a cycle test in a 0.5 C. Table 1 below shows the resistance and capacity retention of each evaluation cell. The resistances shown in Table 1 are the resistances when discharged to SOC60% in the third cycle. The capacity retention ratio is a ratio of the capacity of the tenth cycle to the capacity of the first cycle.

TABLE 1

| | | Soaking | Battery | Capacity |
|---|---|---|---|---|
| | Mg mixture | temperature | resistance | maintaining |
| | layers | (° C.) | (Ω) | rate (%) |
| Comparative | Mg + sulfide | 25 | 137 | 49 |
| Example 1 | | 60 | 66 | 42 |
| Example 1 | Mg + complex | 25 | 98 | 57 |
| | hydride | 60 | 44 | 56 |
| Comparative | None | 25 | 111 | 31 |
| Example 2 | | 60 | 61 | 28 |

From the results shown in Table 1, the following can be seen.
(1) When Mg mixture layer is not disposed between the solid electrolyte layer and SUS foil as in Comparative Example 2, both the cell resistivity and the cycling property are insufficient.
(2) As in Comparative Example 1, when Mg mixture layer is disposed between the solid electrolyte layer and SUS foil and a hard sulfide solid electrolyte is employed in Mg mixture layer, the cycling property is improved as compared with Comparative Example 2, but the improvement is not sufficient. In Comparative Example 1, the battery resistance was slightly higher than that in Comparative Example 2. It is believed that the slightly higher cell resistance is due to the DC resistance of Mg mixture layers. In Comparative Example 1, since the solid electrolyte contained in the solid electrolyte layer and the solid electrolyte contained in Mg mixture layer were of the same type and were both hard, a gap was formed in Mg mixture layer, and the gap could not be eliminated by the solid electrolyte, and consequently, the resistivity and cyclability were reduced.
(3) When a Mg mixture layer is disposed between the solid electrolyte layer and SUS foil and a soft complex hydride solid electrolyte is employed in Mg mixture layer as in Example 1, the resistivity and cycling properties are significantly improved over Comparative Examples 1 and 2. In the first embodiment, the solid electrolyte contained in the solid electrolyte layer and the solid electrolyte contained in Mg mixture layer are different from each other, and the solid electrolyte contained in Mg mixture layer is soft, so that the gap between Mg mixture layer and the like is eliminated by, for example, deforming the soft solid electrolyte. As a result, it is considered that the effect of improving the resistance and the cycle characteristics became large.

In the above embodiment, SUS foil (negative electrode current collector) is protected by Mg layers (protective layers), but the disclosed technique is not limited thereto. Even when the protective layer is omitted, the effect of improving resistance and cycle characteristics is greater in Example 1 than in Comparative Examples 1 and 2. However, it is considered that when the protective layer is provided, resistance and cycle characteristics are more likely to be improved.

In the above embodiment, a combination of a sulfide solid electrolyte and a complex hydride solid electrolyte is exemplified as the solid electrolyte, but the technology of the present disclosure is not limited thereto. When the solid electrolyte (second solid electrolyte) contained in Mg mixture layer is softer than the solid electrolyte (first solid electrolyte) contained in the solid electrolyte layer, that is, when the solid electrolyte has a lower Young's modulus, it is considered that a desired effect is exerted. However, from the viewpoint that (1) ion conductivity is easily secured by the sulfide solid electrolyte, (2) the effect of improving resistance and cycle characteristics is easily obtained by the flexibility of the complex hydride solid electrolyte, and (3) the reactivity of the complex hydride with respect to the sulfide solid electrolyte is small and deterioration of the electrolyte can be suppressed, it is considered that a higher effect is easily obtained when the sulfide solid electrolyte and the complex hydride solid electrolyte are combined in the secondary battery.

As described above, it can be said that the secondary battery having the following configuration has low resistance and cycle characteristics while including the metal lithium negative electrode of the deposition type. That is, the secondary battery of the present disclosure includes (I) a positive electrode, a solid electrolyte layer, a negative electrode current collector, and metallic lithium as a negative electrode active material deposited between the solid electrolyte layer and the negative electrode current collector by charging; (II) a Mg mixture layer is present between the solid electrolyte layer and the negative electrode current collector; (III) the solid electrolyte layer includes a first solid electrolyte; (IV) Mg mixture layer includes a Mg and a second solid electrolyte; and (V) the Young's modulus of the second solid electrolyte is lower than the Young's modulus of the first solid electrolyte.

What is claimed is:

1. A secondary battery comprising:
a positive electrode;
a solid electrolyte layer including a first solid electrolyte;
a negative electrode current collector;
metal lithium as a negative electrode active material deposited between the solid electrolyte layer and the negative electrode current collector by charging; and
a Mg mixture layer existing between the solid electrolyte layer and the negative electrode current collector, the Mg mixture layer including Mg and a second solid electrolyte, wherein a Young's modulus of the second solid electrolyte is lower than a Young's modulus of the first solid electrolyte.

2. The secondary battery according to claim 1, wherein the Young's modulus of the second solid electrolyte is 1 GPa or more and 20 GPa or less.

3. The secondary battery according to claim 1, wherein the first solid electrolyte is a sulfide solid electrolyte.

4. The secondary battery according to claim 1, wherein the second solid electrolyte is a complex hydride containing Li.

5. The secondary battery according to claim 1, further comprising a protective layer existing between the Mg mixture layer and the negative electrode current collector, wherein the protective layer includes Mg and no electrolyte.

6. The secondary battery according to claim 1, wherein the positive electrode includes a lithium-containing oxide as a positive electrode active material.

7. The secondary battery according to claim 1, wherein the negative electrode current collector includes stainless-steel.
